(19) United States
(12) Patent Application Publication
(10) Pub. No.: US 2022/0227254 A1
(43) Pub. Date: Jul. 21, 2022

(54) POWER SUPPLY MANAGEMENT SYSTEM, POWER SUPPLY MANAGEMENT METHOD, AND MANAGEMENT PROGRAM

(71) Applicant: TOYOTA JIDOSHA KABUSHIKI KAISHA, Aichi-ken (JP)

(72) Inventors: Masayuki SUZUKI, Kariya-shi (JP); Atsuko UTSUMI, Toyota-shi (JP); Daigoro MORI, Miyoshi-shi (JP)

(21) Appl. No.: 17/574,550

(22) Filed: Jan. 13, 2022

(30) Foreign Application Priority Data
Jan. 18, 2021 (JP) 2021-005693

(51) Int. Cl. B60L 55/00; H02J 3/32; H02J 7/00; B60L 53/68; B60L 53/66; B60L 53/63; B60L 53/65; G05D 1/02

(52) U.S. Cl. CPC B60L 55/00; H02J 3/322; H02J 7/00712; G05D 1/0297; B60L 53/665; B60L 53/63; B60L 53/65; B60L 53/68

(57) ABSTRACT

A power supply management system according to the present embodiment includes: a prediction apparatus configured to predict occurrence of a power outage in each of a plurality of areas; a plurality of predetermined facilities provided in each of the areas; a plurality of vehicles configured to perform power supply to facilities provided outside the vehicles; and a management apparatus configured to select a vehicle from the vehicles based on position information on each of the vehicles and a hazard area determined, by the prediction apparatus, to be more likely to have a power outage from among the areas, the management apparatus being also configured to notify the selected vehicle of being selected as a vehicle usable for power supply to a predetermined facility provided in the hazard area.

### CROSS-REFERENCE TO RELATED APPLICATION

This application claims priority to Japanese Patent Application No. 2021-005693 filed on Jan. 18, 2021, incorporated herein by reference in its entirety.

### BACKGROUND

### 1. Technical Field

The present disclosure relates to a power supply management system, a power supply management method, and a management program.

### 2. Description of Related Art

Japanese Unexamined Patent Application Publication No. 2017-112806 (JP 2017-112806 A) describes a disaster power supply system configured to, at the time of a power outage due to a disaster, determine emergency facilities as power supply destinations for a plurality of power supply vehicles registered in advance.

### SUMMARY

However, the disaster power supply system described in JP 2017-112806 A does not predict occurrence of a power outage. Accordingly, there is such a problem that, in a case where sufficient electric power is not stored in the power supply vehicles at the time when a power outage occurs, it is difficult to sufficiently supply electric power to the emergency facilities as the power supply destinations of the power supply vehicles. That is, the related art has a problem that, at the time when a power outage occurs, it is difficult to efficiently perform power supply to an emergency facility provided in an area where the power outage occurs.

The present disclosure is accomplished in view of the above problems, and an object of the present disclosure is to provide a power supply management system, a power supply management method, and a management program each of which predicts a hazard area in which a power outage is more likely to occur and prepares power supply to an emergency facility provided in the hazard area before the power outage occurs, so that, even when a power outage occurs, power supply to an emergency facility provided in an area where the power outage occurs can be performed efficiently.

A power supply management system according to one aspect of the present disclosure includes a prediction apparatus, a plurality of predetermined facilities, a plurality of vehicles, and a management apparatus. The prediction apparatus is configured to predict occurrence of a power outage in each of the areas. The predetermined facilities are provided in each of the areas. The vehicles are configured to perform power supply to facilities provided outside the vehicles. The management apparatus is configured to select a vehicle from the vehicles based on position information on each of the vehicles and a hazard area determined, by the prediction apparatus, to be more likely to have a power outage from among the areas. The management apparatus is also configured to notify the selected vehicle of being selected as a vehicle usable for power supply to a predetermined facility provided in the hazard area. The power supply management system can predict a hazard area in which a power outage is more likely to occur and can prepare power supply to an emergency facility provided in the hazard area before the power outage occurs. Hereby, even when a power outage occurs, it is possible to efficiently perform power supply to an emergency facility provided in an area where the power outage occurs.

The management apparatus may instruct the selected vehicle to head to the predetermined facility provided in the hazard area.

In a case where an amount of suppliable electric power of the selected vehicle is less than a predetermined amount, the management apparatus may instruct the selected vehicle to be refilled with energy.

The management apparatus may select, from among the vehicles, a vehicle in which an amount of suppliable electric power is a predetermined amount or more as the vehicle usable for power supply to the predetermined facility.

The management apparatus may preferentially select, from among the vehicles, a vehicle in order of closest to the predetermined facility provided in the hazard area as the vehicle usable for power supply to the predetermined facility.

The management apparatus may notify the selected vehicle of an amount of electric power necessary for power supply to the predetermined facility provided in the hazard area.

The prediction apparatus may predict occurrence of a power outage in each of the areas based on weather forecasts provided from outside.

In a case where a power outage occurs in a neighboring area around the hazard area, the management apparatus may instruct the selected vehicle to head to a predetermined facility provided in the neighboring area.

The power supply management system may include a plurality of energy filling facilities. In a case where an amount of suppliable electric power of the selected vehicle is less than a predetermined amount, the management apparatus may instruct the selected vehicle to be refilled with energy at an energy filling facility near the predetermined facility provided in the hazard area from among the energy filling facilities.

In a case where a power outage occurs in a neighboring area around the hazard area, the management apparatus may instruct the selected vehicle to head to a predetermined facility provided in the neighboring area for power supply, and in a case where an amount of feedable electric power of the selected vehicle is less than a predetermined amount, the management apparatus may instruct the selected vehicle to be refilled with energy at an energy filling facility near the predetermined facility provided in the neighboring area from among the energy filling facilities.

The management apparatus may notify a filling amount of energy necessary for the selected vehicle to the energy filling facility to which the selected vehicle is instructed to head.

The management apparatus may be configured to pay a reward to an owner of the selected vehicle.

A power supply management method according to one aspect of the present disclosure includes: a prediction step of predicting occurrence of a power outage in each of a plurality of areas; a selection step of selecting a vehicle from among a plurality of vehicles configured to perform power supply to facilities provided outside the vehicles, based on position information on each of the vehicles and a hazard area determined, in the prediction step, to be more likely to have a power outage from among the areas; and a notification step of notifying the selected vehicle of being selected as a vehicle usable for power supply to a predetermined facility provided in the hazard area. The power supply management method can predict a hazard area in which a power outage is more likely to occur and can prepare power supply to an emergency facility provided in the hazard area before the power outage occurs. Hereby, even when a power outage occurs, it is possible to efficiently perform power supply to an emergency facility provided in an area where the power outage occurs.

A management program according to one aspect of the present disclosure causes a computer to execute the following processes: a prediction process of predicting occurrence of a power outage in each of a plurality of areas; a selection process of selecting a vehicle from among a plurality of vehicles configured to perform power supply to facilities provided outside the vehicles, based on position information on each of the vehicles and a hazard area determined, in the prediction process, to be more likely to have a power outage from among the areas; and a notification process of notifying the selected vehicle of being selected as a vehicle usable for power supply to a predetermined facility provided in the hazard area. The management program can predict a hazard area in which a power outage is more likely to occur and can prepare power supply to an emergency facility provided in the hazard area before the power outage occurs. Hereby, even when a power outage occurs, it is possible to efficiently perform power supply to an emergency facility provided in an area where the power outage occurs.

With the present disclosure, it is possible to provide a power supply management system, a power supply management method, and a management program each of which predicts a hazard area in which a power outage is more likely to occur and prepares power supply to an emergency facility provided in the hazard area before the power outage occurs, so that, even when a power outage occurs, power supply to an emergency facility provided in an area where the power outage occurs can be performed efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an exemplary configuration of a power supply management system according to Embodiment 1;

FIG. 2 is a flowchart illustrating an operation of the power supply management system illustrated in FIG. 1 before a power outage occurs;

FIG. 3 is a flowchart illustrating an operation of the power supply management system illustrated in FIG. 1 after a power outage has occurred;

FIG. 4 is a block diagram illustrating an exemplary configuration of a power supply management system according to Embodiment 2;

FIG. 5 is a flowchart illustrating an operation of the power supply management system illustrated in FIG. 4 before a power outage occurs; and

FIG. 6 is a flowchart illustrating an operation of the power supply management system illustrated in FIG. 4 after a power outage has occurred.

### DETAILED DESCRIPTION OF EMBODIMENTS

The following describes the present disclosure based on embodiments of the disclosure but are not intended to limit the disclosure according to Claims to the following embodiments. Further, all constituents described in the embodiments are not necessarily essential as the means for solving the problem of the disclosure. The following description and drawings are omitted or simplified appropriately for clarification of the description. In each of the drawings, the same element has the same reference sign, and a redundant description is omitted as needed.

### Embodiment 1

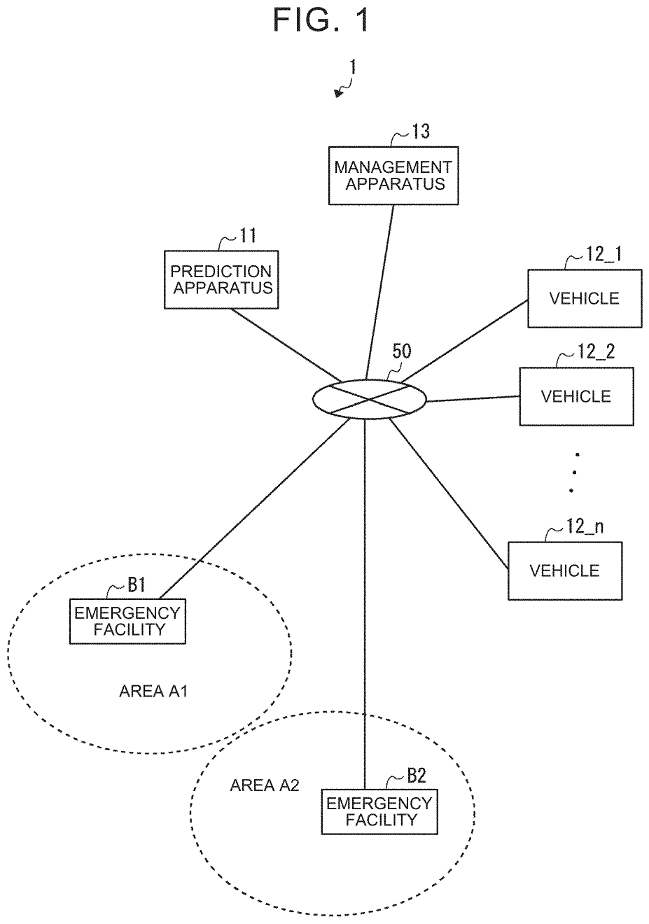

FIG. 1 is a block diagram illustrating an exemplary configuration of a power supply management system 1 according to Embodiment 1. The power supply management system 1 predicts a hazard area in which a power outage is more likely to occur and prepares power supply to an emergency facility provided in the hazard area before the power outage occurs. Hereby, even when a power outage occurs, power supply to an emergency facility provided in an area where the power outage occurs can be performed efficiently. The following describes the power supply management system 1 more specifically.

As illustrated in FIG. 1, the power supply management system 1 includes a prediction apparatus 11, vehicles 12_1 to 12_n (n is an integer number equal to or more than 2), a management apparatus 13, emergency facilities (predetermined facilities) B1, B2, and a network 50. Note that the emergency facility B1 is provided in an area A1, and the emergency facility B2 is provided in an area A2. The prediction apparatus 11, the vehicles 12_1 to 12_n, the emergency facilities B1, B2, and the management apparatus 13 are configured to be communicable to each other via the network 50.

The prediction apparatus 11 predicts occurrence of a power outage in each of a plurality of areas A1 to Am (m is an integer number equal to or more than 2). For example, the prediction apparatus 11 predicts occurrence of a power outage in each of the areas A1 to Am based on an air velocity, a precipitation, a rainfall duration, and so on, in the each of the areas, that are obtained from weather forecasts or the like provided from outside. Note that, as an example, the present embodiment describes a case where the prediction apparatus 11 predicts occurrence of a power outage in each of two areas A1, A2.

The vehicles 12_1 to 12_n are vehicles configured to perform power supply to facilities provided outside the vehicles 12_1 to 12_n and are registered in advance in the power supply management system 1 as vehicles usable for power supply to the facilities provided outside the vehicles 12_1 to 12_n. Each of the vehicles 12_1 to 12_n is a fuel cell vehicle (FCV) provided with fuel cells using hydrogen as power generation fuel, for example. However, the vehicles 12_1 to 12_n may be any types of vehicles, provided that the vehicles 12_1 to 12_n are configured to perform power supply to the facilities provided outside the vehicles 12_1 to 12_n. The vehicles 12_1 to 12_n may be electric vehicles (EV) provided with a chargeable battery, for example. As an example, the present embodiment describes a case where each of the vehicles 12_1 to 12_n is a fuel cell vehicle provided with fuel cells using hydrogen as power generation fuel.

Note that each of the vehicle 12_1 to 12_n is registered to the system, for example, such that an owner or the like of each of the vehicles accesses an entry system managed by the management apparatus 13. Here, a predetermined reward may be paid from an operator of the power supply management system 1 to registrants of the vehicles. Further, an additional reward may be paid to a registrant of a vehicle that performs power supply to an emergency facility at the time when a power outage occurs. More specifically, for example, a system in which a reward is transferred from the management apparatus 13 to a bank account of the registrant of the vehicle may be employed.

Each of the vehicles 12_1 to 12_n includes a communications device including a reception portion configured to receive an instruction content (a notification content) from the management apparatus 13, an output portion configured to output the instruction content thus received, a position information acquisition portion configured to acquire position information on a host vehicle via a GPS or the like, a transmission portion configured to transmit acquisition information acquired by the host vehicle, and so on. Here, the output portion is, for example, a display portion on which the instruction content from the management apparatus 13 is displayed, or a speaker configured to output the instruction content from the management apparatus 13 in an audio manner. Further, as the acquisition information, the transmission portion transmits, to the management apparatus 13, position information on the host vehicle that is acquired by the position information acquisition portion, a residual amount of electric power suppliable by the host vehicle to a facility provided outside the host vehicle, information input into the communications device by a driver or the like of the host vehicle, and so on, for example.

Note that all or some of functions of the communications device provided in each of the vehicles 12_1 to 12_n may be provided in a movable communication terminal possessed by the driver of the host vehicle. The movable communication terminal includes a mobile phone terminal, a smartphone, a tablet terminal, or the like, for example.

The emergency facility B1 is provided in the area A1 and is registered in advance in the power supply management system 1 as a facility usable mainly by people present in the area A1 when a power outage occurs in the area A1. The emergency facility B1 is, for example, an exclusive emergency facility, a gymnasium of a school, a public hall, or the like. However, the emergency facility B1 is not limited to them and may be a predetermined building. Note that, in addition to the emergency facility B1, a plurality of emergency facilities provided in the area A1 may be registered in the power supply management system 1 as facilities usable in case of a power outage.

Note that the emergency facility B1 is registered to the system, for example, such that a manager or the like of the emergency facility B1 accesses the entry system managed by the management apparatus 13. Here, a registration fee may be charged from the operator of the power supply management system 1 to a registrant of the emergency facility B1. Further, an additional fee may be charged in a case where power supply to the emergency facility B1 is performed at the time when a power outage occurs.

The emergency facility B2 is provided in the area A2 and is registered in advance in the power supply management system 1 as a facility usable mainly by people present in the area A2 when a power outage occurs in the area A2. The emergency facility B2 is, for example, an exclusive emergency facility, a gymnasium of a school, a public hall, or the like. However, the emergency facility B2 is not limited to them and may be a predetermined building. Note that, in addition to the emergency facility B2, a plurality of emergency facilities provided in the area A2 may be registered in the power supply management system 1 as facilities usable in case of a power outage.

Note that the emergency facility B2 is registered to the system, for example, such that a manager or the like of the emergency facility B2 accesses the entry system managed by the management apparatus 13. Here, a registration fee may be requested from the operator of the power supply management system 1 to a registrant of the emergency facility B2. Further, an additional fee may be charged in a case where power supply is performed on the emergency facility B2 at the time when a power outage occurs.

Each of the emergency facilities B1, B2 includes, for example, a communications device including a reception portion configured to receive an instruction content (a notification content) from the management apparatus 13, an output portion configured to output the instruction content thus received, a position information acquisition portion configured to acquire position information of the emergency facility via a GPS or the like, a transmission portion configured to transmit acquisition information acquired in the emergency facility, and so on. Here, the output portion is a display portion on which the instruction content from the management apparatus 13 is displayed, or a speaker configured to output the instruction content from the management apparatus 13 in an audio manner. As the acquisition information, the transmission portion transmits, to the management apparatus 13, information on whether or not a power outage occurs in a belonging area, position information of the emergency facility that is acquired by the position information acquisition portion, a necessary amount of electric power, information input into the communications device by the manager or the like of the emergency facility, and so on, for example.

The management apparatus 13 is also called a management server and manages constituents of the power supply management system 1. Here, based on position information on each of the vehicles 12_1 to 12_n, and an area (a hazard area) determined, by the prediction apparatus 11, to be more likely to have a power outage, the management apparatus 13 selects, from among the vehicles 12_1 to 12_n, a vehicle used for power supply to an emergency facility provided in the hazard area. Details of the management apparatus 13 will be described later with the description about the operation of the power supply management system 1.

Operation of Power Supply Management System 1

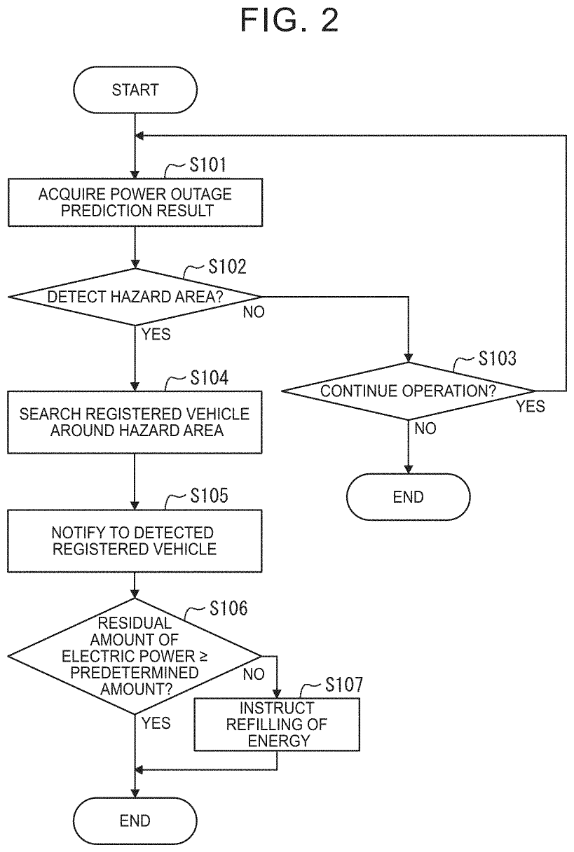

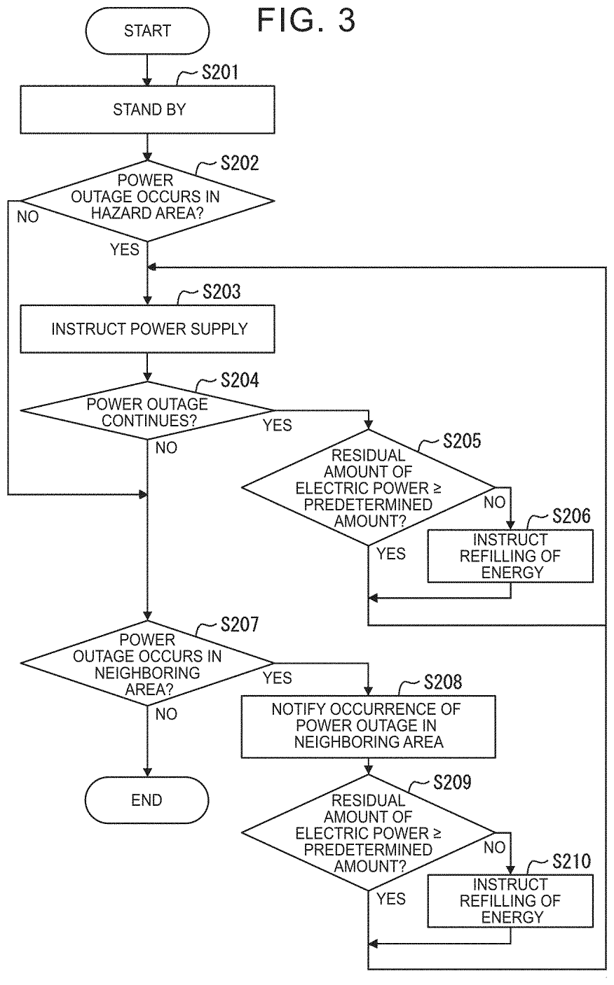

Next will be described the operation of the power supply management system 1 with reference to FIGS. 2, 3.

FIG. 2 is a flowchart illustrating an operation of the power supply management system 1 before occurrence of a power outage.

FIG. 3 is a flowchart illustrating an operation of the power supply management system 1 at the time when a power outage occurs.

Operation of Power Supply Management System 1 Before Occurrence of Power Outage

First described is the operation of the power supply management system 1 before occurrence of a power outage with reference to FIG. 2. The flowchart of FIG. 2 mainly illustrates the procedure of processes performed by the management apparatus 13.

Note that the emergency facilities B1, B2 are registered in the power supply management system 1 in advance as facilities usable at the time when a power outage occurs. The emergency facilities B1, B2 are registered to the system, for example, such that the managers or the like of the emergency facilities B1, B2 access the entry system managed by the management apparatus 13.

Further, the vehicles 12_1 to 12_n are registered in the power supply management system 1 in advance as vehicles usable for power supply to facilities provided outside the vehicles 12_1 to 12_n (to the emergency facilities B1, B2). Each of the vehicle 12_1 to 12_n is registered to the system, for example, such that the owner or the like of the each of the vehicle 12_1 to 12_n accesses the entry system managed by the management apparatus 13.

First, the prediction apparatus 11 predicts occurrence of a power outage in each of the areas A1, A2. The management apparatus 13 acquires a power outage prediction result from the prediction apparatus 11 (step S101).

For example, when the prediction apparatus 11 predicts that the areas A1, A2 are both less likely to have a power outage, that is, when no hazard area is detected (NO in step S102), the management apparatus 13 continuously acquires a power outage prediction result from the prediction apparatus 11 (YES in step S103 step S101), or otherwise, the management apparatus 13 ends the operation of the power supply management system 1 (NO in step S103).

On the other hand, for example, when the prediction apparatus 11 determines that the area A1 is more likely to have a power outage, that is, when the area A1 is detected as a hazard area (YES in step S102), the management apparatus 13 searches a vehicle usable for power supply to the emergency facility B1 provided in the hazard area A1 (step S104).

For example, from among the vehicles 12_1 to 12_n registered in advance, the management apparatus 13 selects the vehicle 12_1 closest to the emergency facility B1 as the vehicle usable for power supply to the emergency facility B1 (step S104).

Note that, when the management apparatus 13 determines that the vehicle 12_1 closest to the emergency facility B1 is not suitable as the vehicle usable for power supply to the emergency facility B1 for some reasons, the management apparatus 13 selects the vehicle 12_2 second closest to the emergency facility B1 as the vehicle usable for power supply to the emergency facility B1. That is, among the vehicles 12_1 to 12_n registered in advance, the management apparatus 13 preferentially selects a vehicle in order of closest to the emergency facility B1 as the vehicle usable for power supply to the emergency facility B1.

After that, the management apparatus 13 notifies the vehicle 12_1 that the vehicle 12_1 is selected as the vehicle usable for power supply to the emergency facility B1 (step S105). The vehicle 12_1 displays a notification content received from the management apparatus 13 on the display portion provided inside the vehicle 12_1 or outputs the notification content from the speaker in an audio manner, for example. Alternatively, instead of notifying the vehicle 12_1 of the notification content, the management apparatus 13 may notify the notification content to a movable communication terminal possessed by a driver of the vehicle 12_1.

Further, the management apparatus 13 may notify a specific notification content to the vehicle 12_1 (or the movable communication terminal possessed by the driver of the vehicle 12_1). Herein, the management apparatus 13 notifies the vehicle 12_1 to head to the emergency facility B1. Hereby, the driver of the vehicle 12_1 drives the vehicle 12_1 to the emergency facility B1 in accordance with the instruction from the management apparatus 13, for example.

Here, in a case where a residual amount of electric power of the vehicle 12_1 (a residual amount of electric power suppliable to the emergency facility B1) is less than a predetermined amount (NO in step S106), the management apparatus 13 instructs the vehicle 12_1 to be refilled with energy (step S107). Hereby, the driver of the vehicle 12_1 refills the vehicle 12_1 with energy (hydrogen) at an energy filling facility. After that, the driver of the vehicle 12_1 drives the vehicle 12_1 to the emergency facility B1 in accordance with the instruction from the management apparatus 13.

Note that the predetermined amount may be an amount of electric power determined in advance or may be determined based on a minimum amount of electric power or the like necessary for power supply to the emergency facility B1 provided in the hazard area A1, for example. The minimum amount of electric power necessary for power supply to the emergency facility B1, a time necessary for the power supply, and so on may be notified from the management apparatus 13 to the vehicle 12_1. Hereby, the driver of the vehicle 12_1 can grasp how much energy the vehicle 12_1 should be refilled with.

On the other hand, in a case where the residual amount of electric power of the vehicle 12_1 is the predetermined amount or more (YES in step S106), the management apparatus 13 does not instruct the vehicle 12_1 to be refilled with energy. On this account, for example, the driver of the vehicle 12_1 drives the vehicle 12_1 to the emergency facility B1 without dropping in at an energy filling facility.

Note that, as an example, the present embodiment deals with a case where the management apparatus 13 preferentially selects a vehicle in order of closest to the emergency facility B1 as the vehicle usable for power supply to the emergency facility B1 regardless of the residual amount of electric power of each vehicle. However, the present embodiment is not limited to this. As the vehicle usable for power supply to the emergency facility B1, the management apparatus 13 may select only a vehicle in which the residual amount of electric power is the predetermined amount or more, from among vehicles close to the emergency facility B1.

Operation of Power Supply Management System 1 when Power Outage Occurs

Next will be described the operation of the power supply management system 1 at the time when a power outage occurs, with reference to FIG. 3. The flowchart of FIG. 3 mainly illustrates the procedure of processes performed by the management apparatus 13.

In the emergency facility B1 in the area A1 determined to be a hazard area before a power outage occurs, the vehicle 12_1 allocated in accordance with the instruction from the management apparatus 13 stands by (step S201). Hereinafter, the area A1 determined to be a hazard area is also referred to as a hazard area A1, and the area A2 as a neighboring area around the hazard area A1 is also referred to as a neighboring area A2.

For example, when a power outage occurs in the hazard area A1 (YES in step S202), the management apparatus 13 instructs the vehicle 12_1 thus standing by to perform power supply to the emergency facility B1 (step S203). In response to this, the driver of the vehicle 12_1 starts power supply from the vehicle 12_1 to the emergency facility B1, for example.

Note that, in a case where the power outage continues in the hazard area A1 even after the power supply to the emergency facility B1 (YES in step S204), the management apparatus 13 instructs the vehicle 12_1 to continuously perform power supply to the emergency facility B1 (YES in step S205→step S203). In response to this, the driver of the vehicle 12_1 continues power supply from the vehicle 12_1 to the emergency facility B1, for example.

However, when the residual amount of electric power of the vehicle 12_1 is less than a predetermined amount (NO in step S205), the management apparatus 13 instructs the vehicle 12_1 to be refilled with energy and then continuously perform power supply to the emergency facility B1 (step S206 step S203). Hereby, the driver of the vehicle 12_1 refills the vehicle 12_1 with energy (hydrogen) at an energy filling facility and then continues power supply to the emergency facility B1 from the vehicle 12_1, for example.

In a case where the hazard area A1 recovers from the power outage (NO in step S204), or in a case where no power outage occurs in the hazard area A1 (NO in step S202), the management apparatus 13 acquires information on whether a power outage occurs in the neighboring area A2 or not from the emergency facility B2 or the like provided in the neighboring area A2, for example (step S207).

For example, in a case where a power outage occurs in the neighboring area A2 (YES in step S207), the management apparatus 13 notifies the vehicle 12_1 that a power outage has occurred in the neighboring area A2 (step S208). Further, in the present embodiment, the management apparatus 13 instructs the vehicle 12_1 to head to the emergency facility B2 in the neighboring area A2. Hereby, the driver of the vehicle 12_1 drives the vehicle 12_1 to the emergency facility B2 in accordance with the instruction from the management apparatus 13, for example.

Then, the management apparatus 13 instructs the vehicle 12_1 to perform power supply to the emergency facility B2 (YES in step S209 step S203). In response to this, the driver of the vehicle 12_1 starts power supply from the vehicle 12_1 to the emergency facility B2, for example.

However, in a case where the residual amount of electric power of the vehicle 12_1 is less than a predetermined amount (NO in step S209), the management apparatus 13 instructs the vehicle 12_1 to be refilled with energy and then perform power supply to the emergency facility B2 (step S210 step S203). Hereby, the driver of the vehicle 12_1 refills the vehicle 12_1 with energy (hydrogen) at an energy filling facility and then starts power supply to the emergency facility B2 from the vehicle 12_1, for example.

Subsequent processes in the neighboring area A2 are similar to the processes in the hazard area A1 (steps S203 to S210).

When no power outage occurs in the neighboring area (NO in step S207) after the processes of steps S201 to S210, the management apparatus 13 causes the vehicle 12_1 to end power supply.

As such, the power supply management system 1 according to the present embodiment predicts a hazard area in which a power outage is more likely to occur and prepares power supply to an emergency facility provided in the hazard area before the power outage occurs. Hereby, even when a power outage occurs, power supply to an emergency facility provided in an area where the power outage occurs can be performed efficiently. Further, even in a case where a power outage occurs in a neighboring area around the hazard area, power supply to an emergency facility provided in the neighboring area can be performed immediately.

Further, in the present embodiment, since power supply to each emergency facility is performed by a registered vehicle, it is not necessary to provide an expensive power generator in each emergency facility. Further, in comparison with a case where a large diesel generator or the like is provided in each emergency facility, it is possible to restrain noise, smell, or the like. Further, even in a case where a power supply amount to each emergency facility is changed, it is possible to deal with the change flexibly. Further, since power supply to each emergency facility is managed by the management apparatus 13, the need to employ human resources having specialized knowledge for each emergency facility is reduced.

As an example, the present embodiment deals with a case where the management apparatus 13 instructs the vehicle 12_1 to prepare power supply to the emergency facility B1 provided in the hazard area A1. However, the present embodiment is not limited to this. Naturally, the management apparatus 13 can instruct the vehicles 12_1 to 12_n to prepare power supply to a given emergency facility provided in a given hazard area.

Further, as an example, the present embodiment deals with a case where the registered vehicle is a vehicle driven by a driver. However, the present embodiment is not limited to this. The registered vehicle may be an autonomously traveling vehicle.

### Embodiment 2

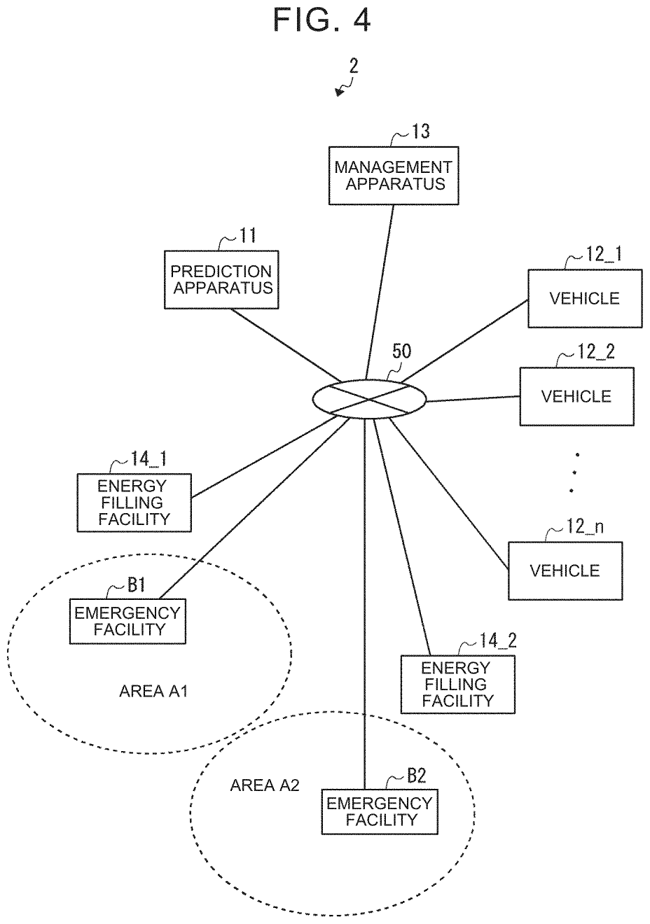

FIG. 4 is a block diagram illustrating an exemplary configuration of a power supply management system 2 according to Embodiment 2. In comparison with the power supply management system 1, the power supply management system 2 further includes a plurality of energy filling facilities 14_1 to 14_p (p is an integer number equal to or more than 2) registered in advance. Note that, as an example, the present embodiment describes a case where the power supply management system 2 includes two energy filling facilities 14_1, 14_2 registered in advance.

The energy filling facilities 14_1, 14_2 are facilities where the vehicles 12_1 to 12_n are refilled with energy and are registered in the power supply management system 1 in advance. Each of the energy filling facilities 14_1, 14_2 is, for example, a hydrogen station for a fuel cell vehicle provided with fuel cells using hydrogen as power generation fuel or is a charging station for an electric vehicle provided with a chargeable battery.

Note that the energy filling facilities 14_1, 14_2 are registered to the system, for example, such that owners or the like of the energy filling facilities 14_1, 14_2 access the entry system managed by the management apparatus 13. Here, a predetermined reward may be paid from an operator of the power supply management system 2 to a registrant of each of the energy filling facilities. Further, an additional reward may be paid to the registrant when energy charging is performed on a registered vehicle at the time when a power outage occurs. More specifically, for example, a system in which a reward is transferred from the management apparatus 13 to a bank account of the registrant of the energy filling facility registrant may be employed.

Each of the energy filling facilities 14_1, 14_2 includes, for example, a communications device including a reception portion configured to receive an instruction content (a notification content) from the management apparatus 13, an output portion configured to output the instruction content thus received, a position information acquisition portion configured to acquire position information of the facility via a GPS or the like, a transmission portion configured to transmit acquisition information acquired by the facility, and so on. Here, the output portion is a display portion on which the instruction content from the management apparatus 13 is displayed, a speaker configured to output the instruction content from the management apparatus 13 in an audio manner, or the like, for example. Further, as the acquisition information, the transmission portion transmits, to the management apparatus 13, position information of the facility that is acquired by the position information acquisition portion, a congestion state, a fillable energy residual amount, an energy filling time at which a registered vehicle is refilled with energy, information input into the communications device by a staff or the like of the facility, and so on, for example.

Other configurations of the power supply management system 2 are similar to those of the power supply management system 1, so that descriptions thereof are omitted.

Operation of Power Supply Management System 2

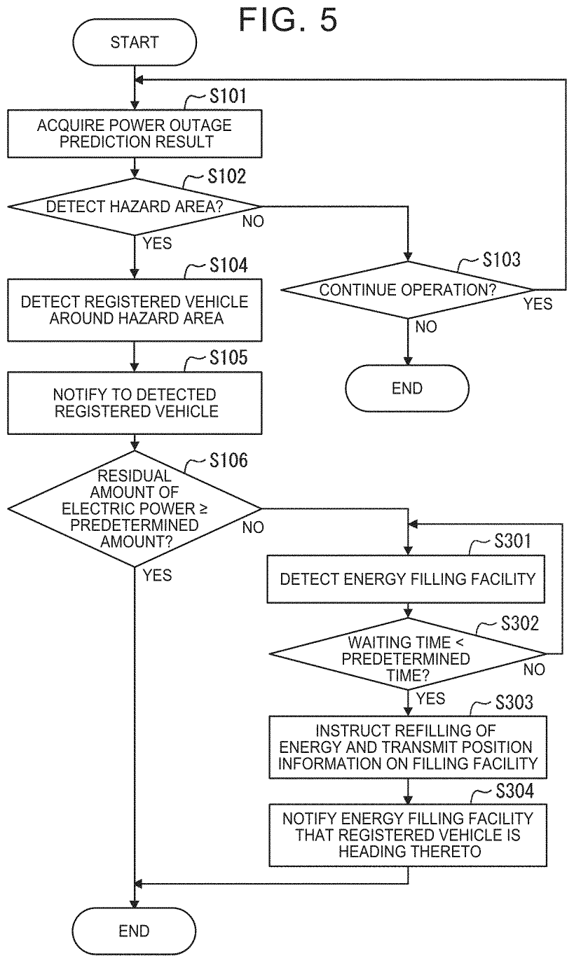

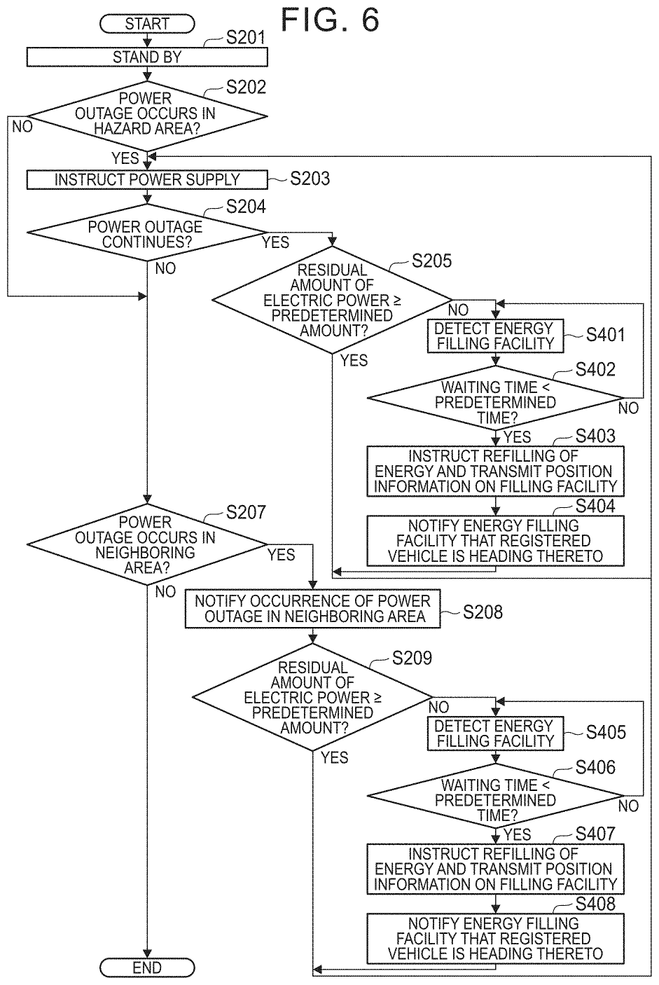

Next will be described the operation of the power supply management system 2 with reference to FIGS. 5, 6.

FIG. 5 is a flowchart illustrating an operation of the power supply management system 2 before occurrence of a power outage.

FIG. 6 is a flowchart illustrating an operation of the power supply management system 2 at the time when a power outage occurs.

Operation of Power Supply Management System 2 Before Occurrence of Power Outage

First described is the operation of the power supply management system 2 before occurrence of a power outage with reference to FIG. 5. The flowchart of FIG. 5 mainly illustrates the procedure of processes performed by the management apparatus 13. The following description mainly deals with matters different from the operation of the power supply management system 1 illustrated in FIG. 2.

After the processes of steps S101 to S105, the management apparatus 13 notifies the vehicle 12_1 that the vehicle 12_1 is selected as the vehicle usable for power supply to the emergency facility B1 (step S105). Further, in the present embodiment, the management apparatus 13 notifies the vehicle 12_1 to head to the emergency facility B1. In response to this, the driver of the vehicle 12_1 drives the vehicle 12_1 to the emergency facility B1 in accordance with the instruction from the management apparatus 13, for example.

Here, in a case where the residual amount of electric power of the vehicle 12_1 is less than a predetermined amount (NO in step S106), the management apparatus 13 detects, for example, the energy filling facility 14_1 closest to the emergency facility B1 (step S301). In a case where a waiting time at the energy filling facility 14_1 is less than a predetermined time (YES in step S302), the management apparatus 13 instructs the vehicle 12_1 to be refilled with energy at the energy filling facility 14_1 (step S303). At this time, the management apparatus 13 may transmit position information on the energy filling facility 14_1 to the vehicle 12_1.

Further, the management apparatus 13 notifies the energy filling facility 14_1 that the vehicle 12_1 is heading to the energy filling facility 14_1 for refilling of energy to the vehicle 12_1 (step S304). At this time, it is preferable that the management apparatus 13 notify the energy filling facility 14_1 of a necessary energy filling amount for the vehicle 12_1, an estimated arrival time, and so on. This allows the energy filling facility 14_1 to secure a sufficient amount of energy before the arrival of the vehicle 12_1.

Note that, in a case where the waiting time at the energy filling facility 14_1 is the predetermined time or more (NO in step S302), the management apparatus 13 detects another energy filling facility 14_2 close to the emergency facility B1 (step S301). After that, the management apparatus 13 performs the processes of steps S302 to S304 similarly to a case where the management apparatus 13 detects the energy filling facility 14_1. The present embodiment assumes a case where the waiting time at the energy filling facility 14_1 is less than the predetermined time.

In this case, for example, the driver of the vehicle 12_1 refills the vehicle 12_1 with energy at the energy filling facility 14_1 in accordance with the instruction from the management apparatus 13, and after that, the driver of the vehicle 12_1 drives the vehicle 12_1 to the emergency facility B1.

On the other hand, in a case where the residual amount of electric power of the vehicle 12_1 is the predetermined amount or more (YES in step S106), the management apparatus 13 does not instruct the vehicle 12_1 to be refilled with energy. On this account, for example, the driver of the vehicle 12_1 drives the vehicle 12_1 to the emergency facility B1 without dropping in at an energy filling facility.

Other operations of the power supply management system 2 before occurrence of a power outage are similar to those of the power supply management system 1, so that descriptions thereof are omitted.

Operation of Power Supply Management System 2 when Power Outage Occurs

Next will be described the operation of the power supply management system 2 at the time when a power outage occurs, with reference to FIG. 6. The flowchart of FIG. 6 mainly illustrates the procedure of processes performed by the management apparatus 13.

In the emergency facility B1 in the area A1 determined to be a hazard area before a power outage occurs, the vehicle 12_1 allocated in accordance with the instruction from the management apparatus 13 stands by (step S201). Hereinafter, the area A1 determined to be a hazard area is also referred to as the hazard area A1, and the area A2 as a neighboring area around the hazard area A1 is also referred to as the neighboring area A2.

For example, when a power outage occurs in the hazard area A1 (YES in step S202), the management apparatus 13 instructs the vehicle 12_1 thus standing by to perform power supply to the emergency facility B1 (step S203). In response to this, the driver of the vehicle 12_1 starts power supply from the vehicle 12_1 to the emergency facility B1, for example.

Note that, in a case where the power outage in the hazard area A1 continues even after power supply to the emergency facility B1 (YES in step S204), the management apparatus 13 instructs the vehicle 12_1 to continuously perform power supply to the emergency facility B1 (YES in step S205 step S203). In response to this, the driver of the vehicle 12_1 continues power supply from the vehicle 12_1 to the emergency facility B1, for example.

However, in a case where the residual amount of electric power of the vehicle 12_1 is less than a predetermined amount (NO in step S205), the management apparatus 13 instructs the vehicle 12_1 to be refilled with energy and then continuously perform power supply to the emergency facility B1.

More specifically, when the residual amount of electric power of the vehicle 12_1 is less than the predetermined amount (NO in step S205), the management apparatus 13 detects, for example, the energy filling facility 14_1 closest to the emergency facility B1 (step S401). In a case where a waiting time at the energy filling facility 14_1 is less than a predetermined time (YES in step S402), the management apparatus 13 instructs the vehicle 12_1 to be refilled with energy at the energy filling facility 14_1 (step S403). At this time, the management apparatus 13 may transmit position information on the energy filling facility 14_1 to the vehicle 12_1.

Further, the management apparatus 13 notifies the energy filling facility 14_1 that the vehicle 12_1 is heading to the energy filling facility 14_1 for refilling of energy (step S404). At this time, it is preferable that the management apparatus 13 notify the energy filling facility 14_1 of a necessary energy filling amount for the vehicle 12_1, an estimated arrival time, and so on. This allows the energy filling facility 14_1 to secure a sufficient amount of energy before the arrival of the vehicle 12_1.

Note that, in a case where the waiting time at the energy filling facility 14_1 is the predetermined time or more (NO in step S402), the management apparatus 13 detects another energy filling facility 14_2 close to the emergency facility B1 (step S401). After that, the management apparatus 13 performs the processes of steps S402 to S404 similarly to a case where the management apparatus 13 detects the energy filling facility 14_1. The present embodiment assumes a case where the waiting time at the energy filling facility 14_1 is less than the predetermined time.

In this case, for example, the driver of the vehicle 12_1 refills the vehicle 12_1 with energy at the energy filling facility 14_1 in accordance with the instruction from the management apparatus 13, and after that, the driver of the vehicle 12_1 returns to the emergency facility B1 and continues power supply from the vehicle 12_1 to the emergency facility B1.

In a case where the hazard area A1 recovers from the power outage (NO in step S204), or in a case where no power outage occurs in the hazard area A1 (NO in step S202), the management apparatus 13 acquires information on whether a power outage occurs in the neighboring area A2 or not from the emergency facility B2 or the like provided in the neighboring area A2, for example (step S207).

For example, in a case where a power outage occurs in the neighboring area A2 (YES in step S207), the management apparatus 13 notifies the vehicle 12_1 that a power outage occurs in the neighboring area A2 (step S208). Further, in the present embodiment, the management apparatus 13 instructs the vehicle 12_1 to head to the emergency facility B2 in the neighboring area A2. In response to this, the driver of the vehicle 12_1 drives the vehicle 12_1 to the emergency facility B2 in accordance with the instruction from the management apparatus 13, for example.

Then, the management apparatus 13 instructs the vehicle 12_1 to perform power supply to the emergency facility B2 (YES in step S209 step S203). In response to this, the driver of the vehicle 12_1 starts power supply from the vehicle 12_1 to the emergency facility B2, for example.

However, in a case where the residual amount of electric power of the vehicle 12_1 is less than a predetermined amount (NO in step S209), the management apparatus 13 instructs the vehicle 12_1 to be refilled with energy and then perform power supply to the emergency facility B2.

More specifically, in a case where the residual amount of electric power of the vehicle 12_1 is less than the predetermined amount (NO in step S209), the management apparatus 13 detects, for example, the energy filling facility 14_2 closest to the emergency facility B2 (step S405). In a case where a waiting time at the energy filling facility 14_2 is less than a predetermined time (YES in step S406), the management apparatus 13 instructs the vehicle 12_1 to be refilled with energy at the energy filling facility 14_2 (step S407). At this time, the management apparatus 13 may transmit position information on the energy filling facility 14_2 to the vehicle 12_1.

Further, the management apparatus 13 notifies the energy filling facility 14_2 that the vehicle 12_1 is heading to the energy filling facility 14_2 for refilling of energy (step S408). At this time, it is preferable that the management apparatus 13 notify the energy filling facility 14_2 of a necessary energy filling amount for the vehicle 12_1, an estimated arrival time, and so on. This allows the energy filling facility 14_2 to secure a sufficient amount of energy before the arrival of the vehicle 12_1.

Note that, in a case where the waiting time at the energy filling facility 14_2 is the predetermined time or more (NO in step S406), the management apparatus 13 detects another energy filling facility 14_1 close to the emergency facility B2 (step S405). After that, the management apparatus 13 performs the processes of steps S406 to S408 similarly to a case where the management apparatus 13 detects the energy filling facility 14_2. The present embodiment assumes a case where the waiting time at the energy filling facility 14_2 is less than the predetermined time.

In this case, for example, the driver of the vehicle 12_1 refills the vehicle 12_1 with energy at the energy filling facility 14_2 in accordance with the instruction from the management apparatus 13, and after that, the driver of the vehicle 12_1 heads to the emergency facility B2 and starts power supply from the vehicle 12_1 to the emergency facility B2.

When no power outage occurs in the neighboring area (NO in step S207) after those processes are performed, the management apparatus 13 instructs the vehicle 12_1 to end power supply.

As such, the power supply management system 2 according to the present embodiment predicts a hazard area in which a power outage is more likely to occur and prepares power supply to an emergency facility provided in the hazard area before the power outage occurs. Hereby, even when a power outage occurs, power supply to an emergency facility provided in an area where the power outage occurs can be performed efficiently. Further, even in a case where a power outage occurs in a neighboring area around the hazard area, power supply to an emergency facility provided in the neighboring area can be performed immediately.

Further, in the power supply management system 2 according to the present embodiment, the energy filling facility registered in advance is notified that a registered vehicle is heading to the energy filling facility for refilling of energy. This allows the energy filling facility to secure a sufficient amount of energy in advance. Further, in the power supply management system 2 according to the present embodiment, by receiving congestion states, position information, and so on from a plurality of energy filling facilities registered in advance, a registered vehicle that requires refilling of energy can be caused to head to an appropriate energy filling facility.

As an example, the present embodiment deals with a case where the management apparatus 13 instructs the vehicle 12_1 to prepare power supply to the emergency facility B1 provided in the hazard area A1. However, the present embodiment is not limited to this. Naturally, the management apparatus 13 can instruct the vehicles 12_1 to 12_n to prepare power supply to a given emergency facility provided in a given hazard area.

Further, as an example, the present embodiment deals with a case where the registered vehicle is a vehicle to be driven by a driver. However, the present embodiment is not limited to this. The registered vehicle may be an autonomously traveling vehicle.

Further, the above embodiment describes this disclosure as a hardware configuration. However, this disclosure is not limited to this. In this disclosure, the control process of the power supply management system can be achieved by causing a central processing unit (CPU) to execute a computer program.

Further, the program described above can be stored by use of various types of non-transitory computer readable media and can be supplied to a computer. The non-transitory computer readable media include various types of tangible storage media. Examples of the non-transitory computer readable media include a magnetic storage medium, a magneto-optical storage medium, a compact disc read only memory (CD-ROM), a CD-R, a CD-R/W, and a semiconductor memory. Examples of the magnetic storage medium are a flexible disc, a magnetic tape, a hard disk drive, and the like. Examples of the magneto-optical storage medium are a magneto-optical disk, and the like. Examples of the semiconductor memory include a mask ROM, a programmable ROM (PROM), an erasable PROM (EPROM), a flash ROM, a random access memory (RAM), and the like. Further, the program can be supplied to the computer by means of various types of transitory computer readable media. Examples of the transitory computer readable media include an electrical signal, an optical signal, and an electromagnetic wave. The transitory computer readable media can supply the programs to the computer via a wired communication channel such as an electric wire or an optical fiber, or a wireless communication channel.

What is claimed is:

1. A power supply management system comprising:
a prediction apparatus configured to predict occurrence of a power outage in each of a plurality of areas;
a plurality of predetermined facilities provided in each of the areas;
a plurality of vehicles configured to perform power supply to facilities provided outside the vehicles; and
a management apparatus configured to select a vehicle from the vehicles based on position information on each of the vehicles and a hazard area determined, by the prediction apparatus, to be more likely to have a power outage from among the areas, the management apparatus being also configured to notify the selected vehicle of being selected as a vehicle usable for power supply to a predetermined facility provided in the hazard area.

2. The power supply management system according to claim 1, wherein the management apparatus instructs the selected vehicle to head to the predetermined facility provided in the hazard area.

3. The power supply management system according to claim 1, wherein, in a case where an amount of suppliable electric power of the selected vehicle is less than a predetermined amount, the management apparatus instructs the selected vehicle to be refilled with energy.

4. The power supply management system according to claim 1, wherein the management apparatus selects, from among the vehicles, a vehicle in which an amount of suppliable electric power is a predetermined amount or more as the vehicle usable for power supply to the predetermined facility.

5. The power supply management system according to claim 1, wherein the management apparatus preferentially selects, from among the vehicles, a vehicle in order of closest to the predetermined facility provided in the hazard area as the vehicle usable for power supply to the predetermined facility.

6. The power supply management system according to claim 1, wherein the management apparatus notifies the selected vehicle of an amount of electric power necessary for power supply to the predetermined facility provided in the hazard area.

7. The power supply management system according to claim 1, wherein the prediction apparatus predicts occurrence of a power outage in each of the areas based on weather forecasts provided from outside.

8. The power supply management system according to claim 1, wherein, in a case where a power outage occurs in a neighboring area around the hazard area, the management apparatus instructs the selected vehicle to head to a predetermined facility provided in the neighboring area.

9. The power supply management system according to claim 1, further comprising a plurality of energy filling facilities, wherein, in a case where an amount of suppliable electric power of the selected vehicle is less than a predetermined amount, the management apparatus instructs the selected vehicle to be refilled with energy at an energy filling facility near the predetermined facility provided in the hazard area from among the energy filling facilities.

10. The power supply management system according to claim 9, wherein:
in a case where a power outage occurs in a neighboring area around the hazard area, the management apparatus instructs the selected vehicle to head to a predetermined facility provided in the neighboring area for power supply, and in a case where an amount of feedable electric power of the selected vehicle is less than a predetermined amount, the management apparatus instructs the selected vehicle to be refilled with energy at an energy filling facility near the predetermined facility provided in the neighboring area from among the energy filling facilities.

11. The power supply management system according to claim 9, wherein the management apparatus notifies a filling amount of energy necessary for the selected vehicle to the energy filling facility to which the selected vehicle is instructed to head.

12. The power supply management system according to claim 1, wherein the management apparatus is configured to pay a reward to an owner of the selected vehicle.

13. A power supply management method comprising:
a prediction step of predicting occurrence of a power outage in each of a plurality of areas;
a selection step of selecting a vehicle from among a plurality of vehicles configured to perform power supply to facilities provided outside the vehicles, based on position information on each of the vehicles and a hazard area determined, in the prediction step, to be more likely to have a power outage from among the areas; and
a notification step of notifying the selected vehicle of being selected as a vehicle usable for power supply to a predetermined facility provided in the hazard area.

14. A management program causing a computer to execute the following processes:
a prediction process of predicting occurrence of a power outage in each of a plurality of areas;
a selection process of selecting a vehicle from among a plurality of vehicles configured to perform power supply to facilities provided outside the vehicles, based on position information on each of the vehicles and a hazard area determined, in the prediction process, to be more likely to have a power outage from among the areas; and
a notification process of notifying the selected vehicle of being selected as a vehicle usable for power supply to a predetermined facility provided in the hazard area.
